(19) United States
(12) Patent Application Publication
(10) Pub. No.: US 2026/0114427 A1
(43) Pub. Date: Apr. 30, 2026

(54) Adjustable Locking Leash Grip

(71) Applicant: Michael Jay Perry, Albany, OR (US)

(72) Inventor: Michael Jay Perry, Albany, OR (US)

(73) Assignee: Michael Jay Perry, Albany, OR (US)

(21) Appl. No.: 18/655,321

(22) Filed: May 6, 2024

(51) Int. Cl. A01K 27/00

(52) U.S. Cl. CPC A01K 27/008; A01K 27/004; A01K 27/009

(57) ABSTRACT

A leash apparatus includes a handle that locks at various positions along the leash for adjustable control and includes additional functionalities such as a training clicker and dispensers for treats and waste bags. The handle can be adjusted and secured without moving parts or with a simple mechanical release system.

### CROSS-REFERENCE TO RELATED APPLICATIONS

This application claims the benefit of U.S. Provisional Patent Application No. 63/464,573, filed under the Electronic Filing System (ESF) ID 47961663, on May 6,2023

### PRIOR ART

Prior art documents such as US20160007572A1, US20120035007A1, US7685972B2, US5351654A, US6223694B1, US11716969B2, GB2528783A, and USD460586S1, as well as US6827045B1, are noted in the field of leash apparatuses. However, they do not disclose the adjustable locking leash grip as described herein.

### BACKGROUND OF THE INVENTION

While various leash apparatuses exist in the prior art, many lack the flexibility and functionality required for effective pet training and management. Existing leashes with fixed-length or limited adjustment capabilities do not adequately address the need for dynamic repositioning during walks or training sessions. Additionally, prior art fails to integrate multiple functionalities, such as a training clicker, treat dispenser, and waste bag dispenser, into a single leash grip.

### SUMMARY OF THE INVENTION

The present invention provides an adjustable locking leash grip designed to address the shortcomings of prior art leash apparatuses. The grip allows for dynamic repositioning along the length of the leash to accommodate various training scenarios and user preferences. Furthermore, it integrates additional functionalities such as a training clicker, a waste bag dispenser, and a treat dispenser, enhancing usability and functionality over traditional leash designs.

### BRIEF DESCRIPTION OF DRAWINGS

The accompanying drawings, which are incorporated into and form a part of this specification, illustrate embodiments of the invention and, together with the detailed description, serve to explain the principles of the invention.

FIG. 1A: Shows a leash with a perpendicular rectangular grip that has no internal moving parts. The leash is locked in place via friction, and its release is achieved by pulling leash material from one end of the grip outwards away from the internal fixed friction parts.

FIG. 1B: Shows one of many possible ways the inside can be formed to create releasable friction without any moving parts.

FIG. 2A: Shows the same leash from FIG. 1 but with an additional clicker.

FIG. 2B: Shows the same leash from FIG. 1 but with a treat dispenser on one end.

FIG. 3A: Shows the same leash from FIG. 1 but with a baggy dispenser on one end.

FIG. 3B: Shows a similar leash to FIG. 1 but with a spherical grip instead of a rectangular grip.

FIG. 4A: Illustrates a Cam buckle mechanical release inside a grip.

FIG. 4B: Illustrates a military slide belt style release inside the grip handle.

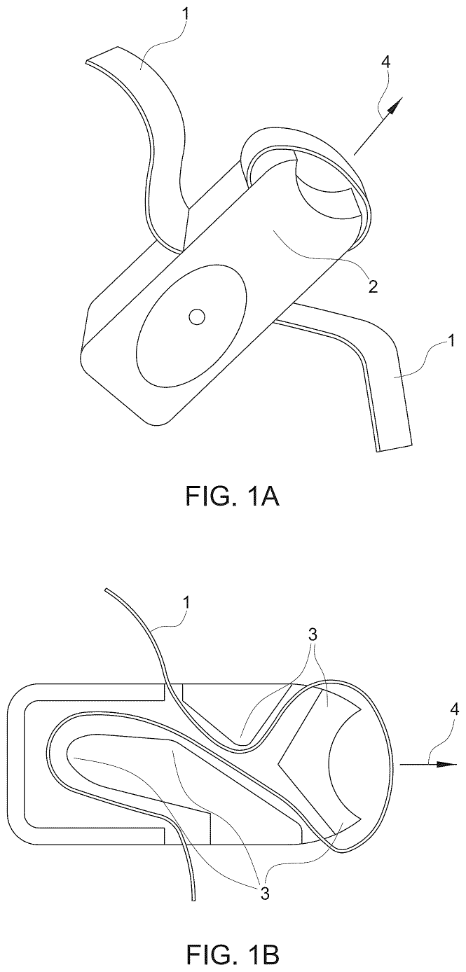

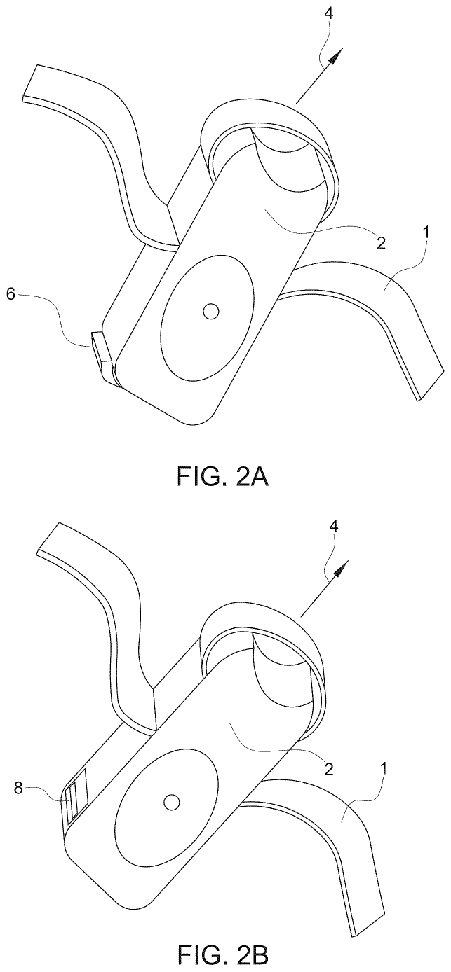

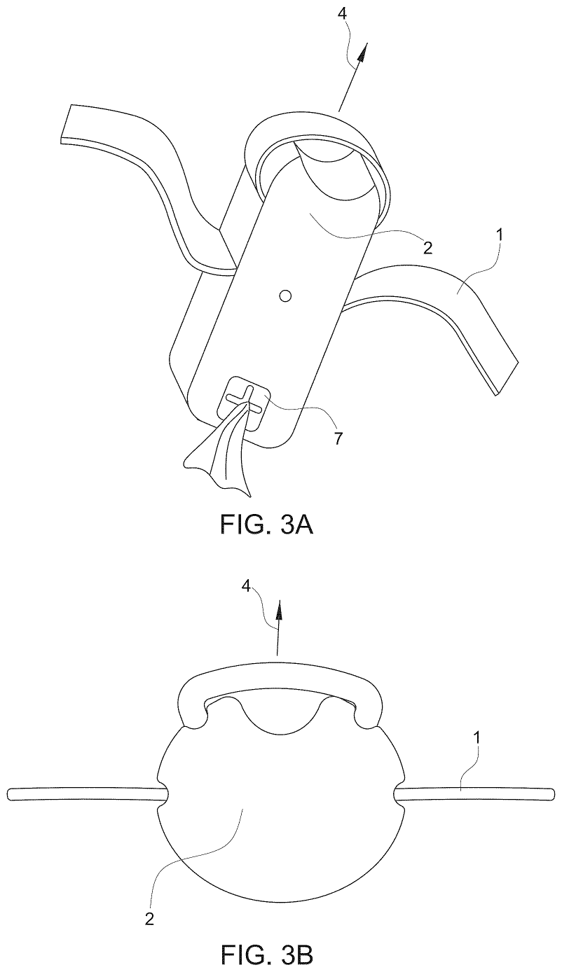

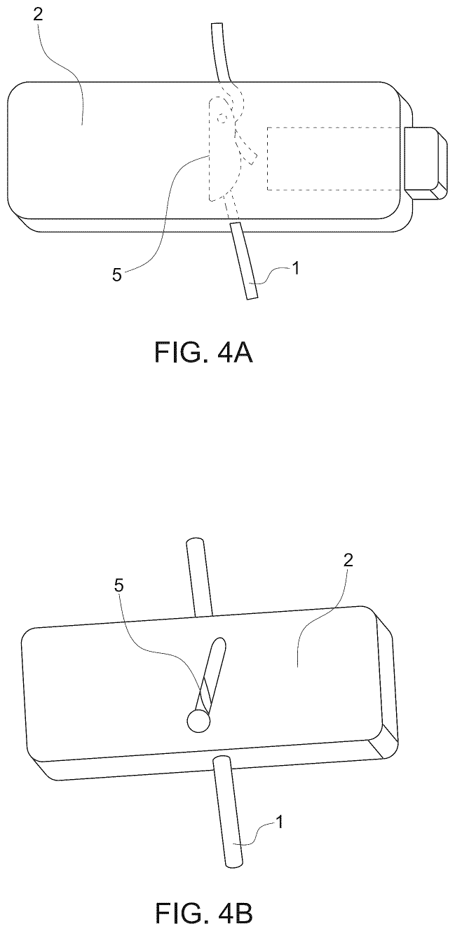

Description of parts:
1. Leash
2. Grip or handle
3. Friction points that lock the grip in place
4. Direction leash is pulled to release it from friction
5. Internal mechanism for creating mechanical friction
6. Training clicker
7. Baggy dispenser
8. Treat dispenser

### DETAILED DESCRIPTION OF THE INVENTION

The adjustable locking leash grip described herein comprises a handle that can be repositioned along the length of the leash, locking means for securing the handle at desired positions, and an integrated mechanism for quick release and adjustment of the grip. This adjustable locking leash grip is designed to complement the standard handle typically found at the end of the leash, as well as the clasp or attachment mechanism on the other end intended to connect to a dog's harness or collar. The grip is ergonomically designed to fit comfortably in a user's hand, allowing for quick and secure adjustments. Friction points are strategically placed to provide a reliable locking mechanism that holds the grip in place under tension. The direction for release outlines the method by which the leash is pulled to release the grip from its locked position. The locking mechanism may include a friction-based system without moving parts for securing the grip in position or may utilize a mechanical release system such as a cam buckle or slide mechanism. Additionally, the grip may include one or more integrated features, such as a training clicker, a waste bag dispenser, and a treat dispenser, to enhance the training and walking experience.

1. An adjustable leash grip comprising: a handle that can be repositioned along the length of the leash; locking means for securing the handle at desired positions; and an integrated mechanism for quick release and adjustment of the grip.

2. The adjustable leash grip of claim 1, wherein the grip includes one or more of: a training clicker, a waste bag dispenser, and a treat dispenser.

3. The adjustable leash grip of claim 1 or 2, wherein the locking mechanism includes a friction-based system without moving parts for securing the grip in position.

4. A method of adjusting a leash grip, comprising the steps of positioning the grip at a desired point along the leash and engaging a locking mechanism to secure the grip in place.
